(19) United States
(12) Patent Application Publication
(10) Pub. No.: US 2024/0325905 A1
(43) Pub. Date: Oct. 3, 2024

(54) DISPLAYING ORIENTATION PROMPT INFORMATION

(71) Applicant: Tencent Technology (Shenzhen) Company Limited, Shenzhen (CN)

(72) Inventors: Jiaqi PAN, Shenzhen (CN); Zefeng YANG, Shenzhen (CN); Linying XIE, Shenzhen (CN); Yinglei WANG, Shenzhen (CN); Weixiang YU, Shenzhen (CN); Yun YANG, Shenzhen (CN); Ying DENG, Shenzhen (CN); Wenyi LI, Shenzhen (CN)

(73) Assignee: Tencent Technology (Shenzhen) Company Limited, Shenzhen (CN)

(21) Appl. No.: 18/744,181

(22) Filed: Jun. 14, 2024

Related U.S. Application Data
(63) Continuation of application No. PCT/CN2023/110606, filed on Aug. 1, 2023.

(30) Foreign Application Priority Data
Sep. 8, 2022 (CN) 202211097497.4

(51) Int. Cl. A63F 13/5375; A63F 13/52; A63F 13/5372; A63F 13/54

(52) U.S. Cl. CPC A63F 13/5375; A63F 13/52; A63F 13/5372; A63F 13/54

(57) ABSTRACT

A method includes displaying a game image including a first virtual character at a first space location in a game scene of a gaming application. The game scene includes a target sound associated with a second space location in the game scene. The method also includes displaying first orientation prompt information of the target sound according to a three-dimensional virtual sphere in the game image. The first orientation prompt information includes a first marker, a second marker, and a first connecting line between the first marker and the second marker. The first marker is located at a first location of the three-dimensional virtual sphere associated with the first space location, the second marker is located at a second location of the three-dimensional virtual sphere associated with the second space location, and the first connecting line indicates a first orientation of the second space location relative to the first space location.

### RELATED APPLICATIONS

The present application is a continuation of International Application No. PCT/CN2023/110606, entitled “ORIENTATION PROMPT INFORMATION DISPLAY METHOD, APPARATUS, STORAGE MEDIUM AND ELECTRONIC DEVICE” and filed on Aug. 1, 2023, which claims priority to Chinese Patent Application No. 202211097497.4, entitled “METHOD AND APPARATUS FOR DISPLAYING ORIENTATION PROMPT INFORMATION, STORAGE MEDIUM, AND ELECTRONIC DEVICE” and filed on Sep. 8, 2022. The entire disclosures of the prior applications are hereby incorporated by reference.

### FIELD OF THE TECHNOLOGY

This disclosure relates to the field of computer technologies, including displaying orientation prompt information.

### BACKGROUND OF THE DISCLOSURE

In a virtual game scene, an orientation prompt of a sound or being-attacked information around a player is generally provided, to help a user determine whether the user is in danger in a current game, or determine an orientation of a virtual character performing a virtual attack.

For example, in a virtual shooting game, a target sound is generally prompted in the following two manners. One manner includes: projecting all sounds on an xz-plane, calculating an angle between a line connecting a sound and the player and a direction that the player faces, and displaying a sound identifier accordingly on a disc around a reticle. The other manner includes: displaying a sound icon in an annular area around a point location of the player on a minimap.

However, in the foregoing two manners, only orientation information of the xz-plane can be expressed, but three-dimensional orientation information in a y-axis direction cannot be accurately distinguished. As a result, the player cannot accurately determine orientation information of the sound, causing a technical problem of low accuracy appearing during displaying of orientation prompt information.

In view of the foregoing problems, no effective solution has been provided yet.

### SUMMARY

Embodiments of this disclosure provide a method and an apparatus for displaying orientation prompt information, a storage medium, and an electronic device, to at least resolve a technical problem of low accuracy appearing during displaying of the orientation prompt information.

According to an aspect of the embodiments of this disclosure, a method for displaying orientation prompt information is provided. The method includes displaying a game image including a first virtual character at a first space location in a game scene of a target gaming application. A target sound associated with a second space location is generated in the game scene. The method also includes displaying first orientation prompt information of the target sound according to a three-dimensional virtual sphere in the game image. The first orientation prompt information includes a first marker, a second marker, and a first connecting line between the first marker and the second marker. The first marker is located at a first location of the three-dimensional virtual sphere, the first location is associated with the first space location of the first virtual character in the game scene, the second marker is located at a second location of the three-dimensional virtual sphere, the second location is associated with the second space location of the target sound in the game scene, and the first connecting line indicates a first orientation of the second space location relative to the first space location.

In some examples, the first location is a center of the three-dimensional virtual sphere. The second location is a surface location on a surface of the three-dimensional virtual sphere and corresponds to a projection of the second space location on the surface of the three-dimensional virtual sphere.

In some embodiments, the first orientation prompt information further includes lines of latitude and longitude of the second marker on the three-dimensional virtual sphere.

In some embodiments, the displaying first orientation prompt information of a target sound in the target gaming application includes: displaying the first marker and the first connecting line in the target gaming application, and displaying the second marker according to a first display parameter, where a value of the first display parameter corresponds to a target distance, and the target distance is a distance between the second space location and the first space location.

In some embodiments, the displaying the second marker according to a first display parameter includes: displaying the second marker according to a transparency parameter in a case that the first display parameter is the transparency parameter, where a value of the transparency parameter indicates transparency of the second marker when the second marker is displayed; or displaying the second marker according to a color parameter in a case that the first display parameter is the color parameter, where a value of the color parameter indicates a color of the second marker when the second marker is displayed.

In some embodiments, the displaying first orientation prompt information of a target sound in the target gaming application includes: displaying the first marker and the first connecting line in the target gaming application, and displaying the second marker according to a second display parameter, where a value of the second display parameter corresponds to intensity of the target sound.

In some embodiments, the displaying the second marker according to a second display parameter includes: displaying a marker of an acoustic wave shape according to an acoustic wave amplitude parameter in a case that the second marker is the marker of the acoustic wave shape and the second display parameter is the acoustic wave amplitude parameter, where a value of the acoustic wave amplitude parameter indicates amplitude of the marker of the acoustic wave shape when the marker of the acoustic wave shape is displayed, and the value of the acoustic wave amplitude parameter is positively correlated with the intensity of the target sound; or displaying a marker of a line shape according to a line height parameter in a case that the second marker is the marker of the line shape and the second display parameter is the line height parameter, where a value of the line height parameter indicates a line height of the marker of the line shape when the marker of the line shape is displayed, and the value of the line height parameter is positively correlated with the intensity of the target sound.

In some embodiments, the method further includes: displaying second orientation prompt information of a second virtual character in the target gaming application in a case that a virtual attack performed by the second virtual character hits the first virtual character, where the second orientation prompt information includes the first marker, a third marker, and a second connecting line between the first marker and the third marker, the third marker is located on the surface of the three-dimensional virtual sphere, the third marker indicates a projection of a third space location of the second virtual character on the three-dimensional virtual sphere, and the second connecting line indicates an orientation of the third space location of the second virtual character relative to the first space location.

In some embodiments, the second orientation prompt information further includes lines of latitude and longitude of the third marker on the three-dimensional virtual sphere.

In some embodiments, the displaying first orientation prompt information of a target sound in the target gaming application includes: displaying, in a case that the surface of the three-dimensional virtual sphere is divided into grids and the second marker corresponds to a target grid on the surface of the three-dimensional virtual sphere, the first marker and the first connecting line in the target gaming application, and displaying the target grid marked in a target color; or displaying, in a case that the surface of the three-dimensional virtual sphere is divided into grids and the second marker corresponds to a target grid on the surface of the three-dimensional virtual sphere, the first marker and the first connecting line in the target gaming application, and displaying a grid in a partial area on the surface of the three-dimensional virtual sphere, where the grid in the partial area includes the target grid marked in a target color and a group of grids; and the group of grids are not marked in a color, or the group of grids are marked in a color different from the target color.

In some embodiments, the method further includes: displaying third orientation prompt information on a thumbnail map in the target gaming application in a case that the target sound is generated at the second space location, where the thumbnail map is configured for displaying planar map information of a three-dimensional game scene in which the first virtual character is located and that is mapped to a target plane, the first space location is on the target plane, the third orientation prompt information includes an orientation of a planar projection location relative to the first space location on the target plane, and a target direction marker, the planar projection location is a projection location of the second space location on the target plane, and the target direction marker is configured for indicating that the second space location is above or below the target plane.

In some embodiments, the displaying first orientation prompt information of a target sound in the target gaming application includes: obtaining the first space location of the first virtual character and the second space location at which the target sound is generated; mapping, according to a same mapping relationship in a case that a distance between the first space location and the second space location is less than or equal to a preset distance threshold, the first space location to the center of the three-dimensional virtual sphere, displaying the first marker on the center of the three-dimensional virtual sphere, and mapping the second space location to a target mapping location in a three-dimensional space of the three-dimensional virtual sphere; and determining a location at which a target connecting line intersects with the surface of the three-dimensional virtual sphere, displaying the second marker at an intersection location, and displaying the first connecting line, where the target connecting line is a connecting line passing through the center of the three-dimensional virtual sphere and the target mapping location.

According to another aspect of the embodiments of this disclosure, an apparatus includes processing circuitry configured to display a game image including a first virtual character at a first space location in a game scene of a target gaming application, a target sound associated with a second space location is generated in the game scene. The processing circuitry is also configured to display first orientation prompt information of the target sound according to a three-dimensional virtual sphere in the game image. The first orientation prompt information includes a first marker, a second marker, and a first connecting line between the first marker and the second marker, the first marker is located at a first location of the three-dimensional virtual sphere, the first location is associated with the first space location of the first virtual character in the game scene, the second marker is located at a second location of the three-dimensional virtual sphere, the second location is associated with the second space location of the target sound in the game scene, and the first connecting line indicates a first orientation of the second space location relative to the first space location.

According to still another aspect of the embodiments of this disclosure, a non-transitory computer-readable storage medium is further provided, having a computer program stored therein, the computer program being configured to, when run, perform the foregoing method for displaying orientation prompt information.

According to still another aspect of the embodiments of this disclosure, a computer program product is further provided, including a computer program or instructions, the computer program or instructions, when executed by a processor, implementing operations of the foregoing method.

According to still another aspect of the embodiments of this disclosure, an electronic device is further provided, including a memory and a processor, the memory having a computer program stored therein, and the processor being configured to perform the foregoing method for displaying orientation prompt information through the computer program.

Through the foregoing embodiments provided in this disclosure, in the displayed game picture (game image) of the first virtual character, the second space location of the target sound and the first space location of the first virtual character are respectively mapped to the center (the first marker) of the three-dimensional virtual sphere and the second marker on the surface, and the orientation of the second space location relative to the first space location is indicated by using the first connecting line between the first marker and the second marker. In other words, display information in a y-axis direction is added in the three-dimensional virtual sphere, so that the orientation prompt information of the target sound is more accurate, the technical problem of low accuracy appearing during displaying of the orientation prompt information is avoided, and a technical effect of improving accuracy of displaying the orientation prompt information is achieved.

### BRIEF DESCRIPTION OF THE DRAWINGS

The accompanying drawings described herein are used to provide a further understanding of this disclosure, and constitute a part of this disclosure. Exemplary embodiments of this disclosure and descriptions thereof are configured for explaining this disclosure, and do not constitute any inappropriate limitation to this disclosure. In the accompany drawings:

FIG. 1 is an exemplary schematic diagram of an application scenario of a method for displaying orientation prompt information according to an embodiment of this disclosure.

FIG. 2 is an exemplary flowchart of a method for displaying orientation prompt information according to an embodiment of this disclosure.

FIG. 3 is an exemplary schematic diagram (1) of a method for displaying orientation prompt information according to an embodiment of this disclosure.

FIG. 4 is an exemplary schematic diagram (2) of a method for displaying orientation prompt information according to an embodiment of this disclosure.

FIG. 5 is a comparison diagram of display forms of a 2D planar version and a 3D spherical version of orientation prompt information of a target sound.

FIG. 6 is an exemplary schematic diagram (1) of displaying a second marker according to a first display parameter according to an embodiment of this disclosure.

FIG. 7 is an exemplary schematic diagram (2) of displaying a second marker according to a first display parameter according to an embodiment of this disclosure.

FIG. 8 is an exemplary schematic diagram of displaying a second marker according to a first display parameter and a display parameter of a game picture according to an embodiment of this disclosure.

FIG. 9 is an exemplary schematic diagram of displaying a second marker according to a second display parameter according to an embodiment of this disclosure.

FIG. 10 is an exemplary schematic diagram (3) of a method for displaying orientation prompt information according to an embodiment of this disclosure.

FIG. 11 is an exemplary schematic diagram (4) of a method for displaying orientation prompt information according to an embodiment of this disclosure.

FIG. 12 is an exemplary schematic diagram (5) of a method for displaying orientation prompt information according to an embodiment of this disclosure.

FIG. 13 shows an overall flowchart of a method for displaying orientation prompt information and a schematic diagram of a mapping relationship according to an embodiment of this disclosure.

FIG. 14 is an exemplary schematic structural diagram of an apparatus for displaying orientation prompt information according to an embodiment of this disclosure.

FIG. 15 is an exemplary schematic structural diagram of an electronic device according to an embodiment of this disclosure.

### DESCRIPTION OF EMBODIMENTS

The technical solutions in the embodiments of this disclosure are described below with reference to the accompanying drawings in the embodiments of this disclosure.

In the specification, claims, and the accompanying drawings of this disclosure, the terms “first”, “second”, and the like are intended to distinguish between similar objects but do not necessarily indicate a specific order or sequence. Data used in this way is interchangeable in a suitable case, so that the embodiments of this disclosure described herein can be implemented in an order other than those illustrated or described herein. Furthermore, the terms “comprise”, “have”, and any variants thereof are intended to cover non-exclusive inclusion. For example, a process, a method, a system, a product, or a device that includes a series of operations or units is not necessarily limited to those explicitly listed operations or units, but may include other operations or units not explicitly listed or inherent to the process, the method, the product, or the device.

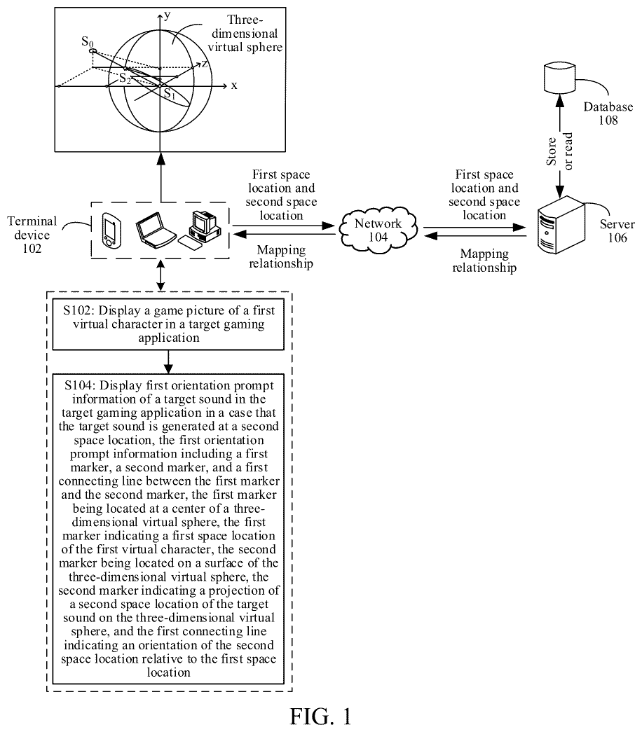

According to an aspect of the embodiments of this disclosure, a method for displaying orientation prompt information is provided. In an exemplary implementation, the method for displaying orientation prompt information is applicable to, but is not limited to, an application scenario shown in FIG. 1. In the application scenario shown in FIG. 1, a terminal device 102 may communicate with a server 106 through a network 104, but is not limited thereto. The server 106 may perform an operation such as a data writing operation or a data reading operation on a database 108, but is not limited thereto. The foregoing terminal device 102 may include, but is not limited to, a human-machine interaction screen, a processor, and a memory. The foregoing human-machine interaction screen may be configured to display a game picture on the terminal device 102, a second marker on a three-dimensional virtual sphere, a first connecting line between a first marker and the second marker, and the like, but is not limited thereto. The foregoing processor may be configured to, in response to a human-machine interaction operation, perform a corresponding operation, or generate corresponding instructions and send the generated instructions to the server 106, but is not limited thereto. The foregoing memory is configured to store related processing data such as a first space location, a second space location, and the first connecting line.

In an exemplary manner, the following operations in the method for displaying orientation prompt information may be performed on the server 106. Operation S102: Display a game picture of a first virtual character in a target gaming application. Operation S104: Display first orientation prompt information of a target sound in the target gaming application in a case that the target sound is generated at a second space location, the first orientation prompt information including a first marker, a second marker, and a first connecting line between the first marker and the second marker, the first marker being located at a center of a three-dimensional virtual sphere, the first marker indicating a first space location of the first virtual character, the second marker being located on a surface of the three-dimensional virtual sphere, the second marker indicating a projection of a second space location of the target sound on the three-dimensional virtual sphere, and the first connecting line indicating an orientation of the second space location relative to the first space location.

In an example, execution entities of the foregoing operations S102 to S104 are not limited in the embodiments. For example, the foregoing operations S102 to S104 all may be performed on the terminal device 102 or the server 106, or may be partially performed on the terminal device 102 and partially performed on an operation server communicating with the server 106.

By using the foregoing manner, in the displayed game picture of the first virtual character, the second space location of the target sound and the first space location of the first virtual character are respectively mapped to the center (the first marker) of the three-dimensional virtual sphere and the second marker on the surface, and the orientation of the second space location relative to the first space location is indicated by using the first connecting line between the first marker and the second marker. In other words, display information in a y-axis direction is added in the three-dimensional virtual sphere, so that the orientation prompt information of the target sound is more accurate, the technical problem of low accuracy appearing during displaying of the orientation prompt information is avoided, and a technical effect of improving accuracy of displaying the orientation prompt information is achieved.

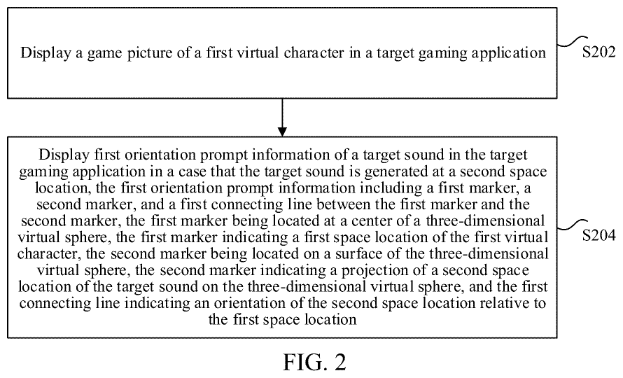

To resolve the foregoing problem of low accuracy appearing during displaying of the orientation prompt information, the embodiments of this disclosure provide a method for displaying orientation prompt information. FIG. 2 is a flowchart of a method for displaying orientation prompt information according to an embodiment of this disclosure. A procedure includes the following operations.

Operation S202: Display a game picture of a first virtual character in a target gaming application.

Operation S204: Display first orientation prompt information of a target sound in the target gaming application in a case that the target sound is generated at a second space location, the first orientation prompt information including a first marker, a second marker, and a first connecting line between the first marker and the second marker, the first marker being located at a center of a three-dimensional virtual sphere, the first marker indicating a first space location of the first virtual character, the second marker being located on a surface of the three-dimensional virtual sphere, the second marker indicating a projection of a second space location of the target sound on the three-dimensional virtual sphere, and the first connecting line indicating an orientation of the second space location relative to the first space location.

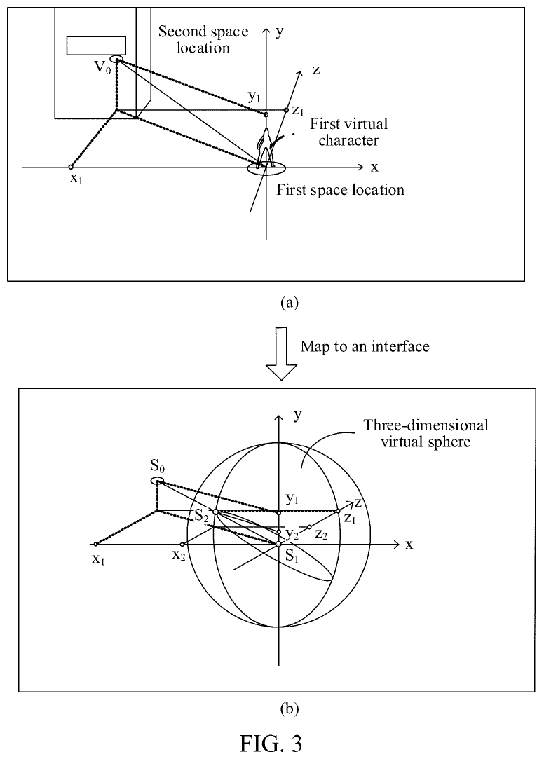

As shown in (a) in FIG. 3, it is assumed that in the game picture displayed in the target gaming application, the first virtual character is located at the first space location, and a target sound V₀ is generated at the second space location. The target sound V₀ may be, but is not limited to, a sound emitted by each scene element in a current game scene, such as a roar emitted by a virtual animal, or a gunshot emitted when a virtual character other than the first virtual character shoots.

After the space location of the first virtual character and the space location of the target sound are obtained, the first virtual character is displayed at a center S₁ of the three-dimensional virtual sphere shown in (b) in FIG. 3, the target sound V₀ is displayed at a second marker S₂ on the surface of the three-dimensional virtual sphere, and an orientation of the target sound V₀ relative to the first virtual character is indicated by using a first connecting line between a first marker S₁ and the second marker S₂, for example, the target sound V₀ is behind and at the left of the first virtual character, so that a player can accurately determine the orientation of the target sound.

In the related art, generally, the first virtual character and the target sound V₀ are separately mapped in an xz-coordinate system shown in (a) in FIG. 5. However, through S₂ in the planar coordinate system, only an approximate orientation of the target sound relative to the first virtual character on an xz-plane can be determined. For example, it can be only determined that the target sound is at the right of the first virtual character, but a relative space location relationship between the target sound and the first virtual character on a y axis cannot be accurately obtained. In other words, that the target sound is in front of and at the right of the first virtual character or the target sound is behind and at the right of the first virtual character cannot be accurately obtained. However, the player may quickly determine that the target sound is behind and at the right of the first virtual character through orientation prompt information shown in (b) in FIG. 5.

The target sound V₀ may be, but is not limited to, the sound emitted by each scene element in the current game scene, or the gunshot emitted when the virtual character other than the first virtual character shoots (which may also be understood as a sound of a virtual attack suffered by the first virtual character). Therefore, the first orientation prompt information in this embodiment of this disclosure includes, but is not limited to, orientation information of the target sound and orientation information of the first virtual character when being attacked.

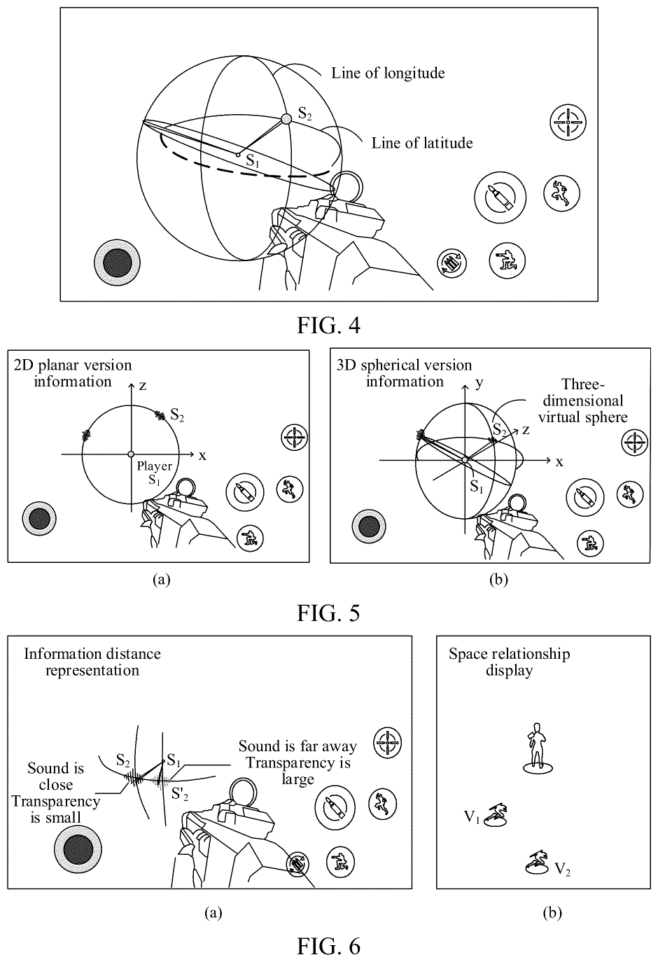

As shown in FIG. 4, to make the first orientation prompt information of the target sound displayed in a game interface more intuitive, the player is assisted in determining the orientation of the target sound generally with the help of lines of latitude and longitude on the three-dimensional virtual sphere. Specifically,

the first marker, the second marker, the first connecting line, and lines of latitude and longitude of the second marker on the three-dimensional virtual sphere are displayed in the target gaming application. The first orientation prompt information further includes the lines of latitude and longitude of the second marker on the three-dimensional virtual sphere.

Apparently, the lines of latitude and longitude are lines for determining a location and a direction on the three-dimensional virtual sphere. A line of longitude indicates a north-south direction, and a line of latitude indicates an east-west direction. In a three-dimensional virtual sphere shown in (b) in FIG. 5, a first relative location relationship between the second marker S₂ and the first marker S₁ on the xy-plane may be displayed by using a line of latitude for assistance, and a second relative location relationship between the second marker S₂ and the first marker S₁ in the y-axis direction may be displayed by using a line of longitude for assistance. In combination with the first relative location relationship and the second relative location relationship, it may be quickly determined that the target sound is behind and at the right of the first virtual character.

The first orientation prompt information of the target sound shown in FIG. 3 is merely an example and is not limited. For example, in an actual application scenario, a plurality of, such as two, three, or another quantity of, pieces of orientation prompt information of a plurality of target sounds may also be simultaneously displayed on the three-dimensional virtual sphere.

Through the foregoing embodiment provided in this disclosure, in the displayed game picture of the first virtual character, the second space location of the target sound and the first space location of the first virtual character are respectively mapped to the center (the first marker) of the three-dimensional virtual sphere and the second marker on the surface, and the orientation of the second space location relative to the first space location is indicated by using the first connecting line between the first marker and the second marker. In other words, display information in a y-axis direction is added in the three-dimensional virtual sphere, so that the orientation prompt information of the target sound is more accurate, the technical problem of low accuracy appearing during displaying of the orientation prompt information is avoided, and a technical effect of improving accuracy of displaying the orientation prompt information is achieved.

In an example, the displaying first orientation prompt information of a target sound in the target gaming application includes:
displaying the first marker and the first connecting line in the target gaming application, and displaying the second marker according to a first display parameter, where a value of the first display parameter corresponds to a target distance, and the target distance is a distance between the second space location and the first space location.

In this embodiment, to more intuitively display the target distance between the second space location and the first space location shown in (a) in FIG. 3, during displaying of the second marker, refer to the value of the first display parameter corresponding to the target distance for display. Specifically,
the second marker is displayed according to a transparency parameter in a case that the first display parameter is the transparency parameter, where a value of the transparency parameter indicates transparency of the second marker when the second marker is displayed; or
the second marker is displayed according to a color parameter in a case that the first display parameter is the color parameter, where a value of the color parameter indicates a color of the second marker when the second marker is displayed.

In this embodiment, the first display parameter may be configured for distinguish different parameters, such as the transparency parameter and the color parameter, of the distance between the target sound and the first virtual character, but is not limited thereto. Parameters of two different types are described in detail below with reference to specific embodiments.

### Embodiment 1

It is assumed that the distance between the target sound and the first virtual character is distinguished by using the transparency parameter. In this case, the value of the transparency parameter is positively correlated with the target distance, or the value of the transparency parameter is positively correlated with an interval boundary value of a distance interval of the target distance.

For example, it is assumed that the value of the transparency parameter is A, the target distance is B, and a relationship between A and B is that A=1.5B. To be specific, when the distance between the target sound and the first virtual character is short, transparency is small, for example, a second marker S₂ shown in (a) in FIG. 6; and when the distance between the target sound and the first virtual character is long, transparency is large, for example, a second marker S′₂ shown in (a) in FIG. 6. From a space relationship display result shown in (b) in FIG. 6, a second space location of a target sound V₁ is close to the first virtual character, and a second space location of a target sound V₂ is far away from the first virtual character. In this case, when the second marker S₂ and the second marker S′₂ are displayed, a value of a transparency parameter of S₂ is less than a value of a transparency parameter of S′₂.

For another example, it is assumed that a value range of the transparency parameter is [0, 1]. When the target distance B is less than 50 meters, the value A of the transparency parameter is equal to 0.3; when the target distance B is greater than or equal to 50 meters and is less than 100 meters, the value A of the transparency parameter is equal to 0.6; and when the target distance B is greater than or equal to 100 meters, the value A of the transparency parameter is equal to 0.9. In other words, the value of the transparency parameter is positively correlated with the interval boundary value of the distance interval of the target distance.

In another example, it is assumed that the distance between the target sound and the first virtual character is distinguished by using the transparency parameter. In this case, the value of the transparency parameter is negatively correlated with the target distance, or the value of the transparency parameter is negatively correlated with the interval boundary value of the distance interval of the target distance.

For example, it is assumed that the value of the transparency parameter is A, the target distance is B, a relationship between A and B is that A=C−B, and C is a constant. To be specific, when the distance between the target sound and the first virtual character is short, the value of the transparency parameter is large; and when the distance between the target sound and the first virtual character is long, the value of the transparency parameter is small.

For another example, it is assumed that a value range of the transparency parameter is [0, 1]. When the target distance B is less than 50 meters, the value A of the transparency parameter is equal to 0.9; when the target distance B is greater than and equal to 50 meters and is less than 100 meters, the value A of the transparency parameter is equal to 0.6; and when the target distance B is greater than or equal to 100 meters, the value A of the transparency parameter is equal to 0.3. In other words, the value of the transparency parameter is negatively correlated with the interval boundary value of the distance interval of the target distance.

### Embodiment 2

It is assumed that the distance between the target sound and the first virtual character is distinguished by using the color parameter. In this case, the value of the color parameter is positively correlated with the target distance, or the value of the color parameter is positively correlated with an interval boundary value of a distance interval of the target distance.

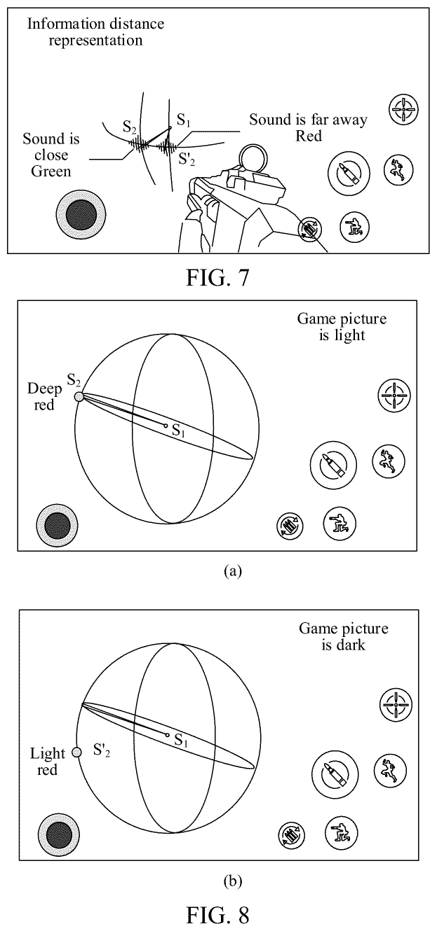

For example, it is assumed that the value of the color parameter is Q. When Q=10, green is indicated; when Q=20, yellow is indicated; and when Q=30, red is indicated. A greater value of Q indicates a longer distance between the target sound and the first virtual character. In this case, it is assumed that a relationship between the value Q of the color parameter and the target distance B is that Q=0.5B. When the distance between the target sound and the first virtual character is 20 meters, a color of a second marker S₂ is green, for example, a second marker S₂ shown in FIG. 7; when the distance between the target sound and the first virtual character is 40 meters, the color of the second marker S₂ is yellow; and when the distance between the target sound and the first virtual character is 60 meters, the color of the second marker S₂ is red, for example, a second marker S′₂ shown in FIG. 7.

For another example, it is assumed that the value of the color parameter is Q, and Q=1, 2, or 3, where 1 indicates green, 2 indicates yellow, and 3 indicates red. In addition, a greater value of Q indicates a longer distance between the target sound and the first virtual character. When the target distance B is less than 50 meters, the value Q of the color parameter is equal to 1, and the second marker is displayed in green; when the target distance B is greater than or equal to 50 meters and is less than 100 meters, the value Q of the color parameter is equal to 2, and the second marker is displayed in yellow; and when the target distance B is greater than or equal to 100 meters, the value Q of the color parameter is equal to 3, and the second marker is displayed in red. In other words, the value of the color parameter is positively correlated with the interval boundary value of the distance interval of the target distance.

In another example, it is assumed that the distance between the target sound and the first virtual character is distinguished by using the color parameter. In this case, the value of the color parameter is negatively correlated with the target distance, or the value of the color parameter is negatively correlated with the interval boundary value of the distance interval of the target distance.

For example, it is assumed that the value of the color parameter is Q. When Q=10, red is indicated; when Q=20, yellow is indicated; and when Q=30, green is indicated. A greater value of Q indicates a shorter distance between the target sound and the first virtual character. In this case, it is assumed that a relationship between the value Q of the color parameter and the target distance B is that Q=0.5B. When the distance between the target sound and the first virtual character is 20 meters, a color of the second marker S₂ is red; when the distance between the target sound and the first virtual character is 40 meters, the color of the second marker S₂ is yellow; and when the distance between the target sound and the first virtual character is 60 meters, the color of the second marker S₂ is green.

For another example, it is assumed that the value of the color parameter is Q, and Q=1, 2, or 3, where 1 indicates red, 2 indicates yellow, and 3 indicates green. In addition, a greater value of Q indicates a shorter distance between the target sound and the first virtual character. When the target distance B is less than 50 meters, the value Q of the color parameter is equal to 1, and the second marker is displayed in red; when the target distance B is greater than or equal to 50 meters and is less than 100 meters, the value Q of the color parameter is equal to 2, and the second marker is displayed in yellow; and when the target distance B is greater than or equal to 100 meters, the value Q of the color parameter is equal to 3, and the second marker is displayed in green. In other words, the value of the color parameter is positively correlated with the interval boundary value of the distance interval of the target distance.

In still another example, when the distance between the target sound and the first virtual character is distinguished by using the color parameter, values of the color parameter may also respectively indicate different color depths of a same color. For example, for the same color, the color parameter includes a plurality of values from light to dark. In addition, the value of the color parameter is positively correlated with the target distance, or the value of the color parameter is positively correlated with the interval boundary value of the distance interval of the target distance. For a description process of positive correlation, refer to the foregoing embodiment, and details are not described herein again.

Correspondingly, when the distance between the target sound and the first virtual character is distinguished by using the color parameter, values of the color parameter may also respectively indicate different color depths of a same color. For example, for the same color, the color parameter includes a plurality of values from light to dark. In addition, the value of the color parameter is negatively correlated with the target distance, or the value of the color parameter is negatively correlated with the interval boundary value of the distance interval of the target distance. For a specific description process of negative correlation, refer to the foregoing embodiment, and details are not described herein again.

In addition, that the second marker is displayed according to a color parameter further includes:
the value of the color parameter is determined according to a display parameter of the game picture of the first virtual character and the target distance, where a color difference between a color indicated by the value of the color parameter and a color indicated by the display parameter of the game picture is greater than a preset threshold; and
the second marker in a target color is displayed, where the target color is the color indicated by the value of the color parameter.

It is assumed that the display parameter of the game picture of the first virtual character may be, but is not limited to, lightness of the game picture, and lightness of a first game picture seen by a first virtual character located at a first space location V₁ is high. In this case, a first value of a color parameter of the second marker is determined according to a first target distance between the first space location V₁ and the target sound, and the lightness of the first game picture. For example, as shown in (a) in FIG. 8, the second marker is displayed in deep red according to the first value.

In a case that the first virtual character moves to a first space location V′₁ and lightness of a second game picture seen by the first virtual character located at the first space location V′₁ is low, a second value of the color parameter of the second marker is determined according to a second target distance between the first space location V′₁ and the target sound, and the lightness of the second game picture. For example, as shown in (b) in FIG. 8, the second marker is displayed in light red according to the second value.

By using the foregoing manners, the second marker is displayed according to the value of the transparency parameter and the value of the color parameter separately. In addition, during displaying of the second marker according to the value of the color parameter, the display parameter of the game picture is further taken into account, so that the player can visually distinguish the distance between the target sound and the first virtual character more easily, thereby displaying the orientation prompt information more intuitively.

When the first orientation prompt information of the target sound is displayed, the second marker may also be displayed according to a second display parameter other than the first display parameter. Specifically,

the first marker and the first connecting line are displayed in the target gaming application, and the second marker is displayed according to the second display parameter, where a value of the second display parameter corresponds to intensity of the target sound.

In this embodiment of this disclosure, if the player intends to quickly and accurately determine the relative space location relationship between the target sound and the first virtual character, the player may be further assisted by using the intensity of the target sound other than the distance information displayed when the second marker is displayed according to the foregoing first display parameter, to more accurately determine orientation information of the target sound.

In an example, that the second marker is displayed according to the second display parameter includes:
a marker of an acoustic wave shape is displayed according to an acoustic wave amplitude parameter in a case that the second marker is the marker of the acoustic wave shape and the second display parameter is the acoustic wave amplitude parameter, where a value of the acoustic wave amplitude parameter indicates amplitude of the marker of the acoustic wave shape when the marker of the acoustic wave shape is displayed, and the value of the acoustic wave amplitude parameter is positively correlated with the intensity of the target sound; or
a marker of a line shape is displayed according to a line height parameter in a case that the second marker is the marker of the line shape and the second display parameter is the line height parameter, where a value of the line height parameter indicates a line height of the marker of the line shape when the marker of the line shape is displayed, and the value of the line height parameter is positively correlated with the intensity of the target sound.

An implementation process of displaying the second marker according to the second display parameter is described below with reference to specific embodiments.

### Embodiment 3

It is assumed that the intensity of the target sound is distinguished by using the acoustic wave amplitude parameter. In this case, the value of the acoustic wave amplitude parameter is positively correlated with the intensity of the target sound, or the value of the acoustic wave amplitude parameter is positively correlated with an interval boundary value of an intensity interval of the intensity of the target sound.

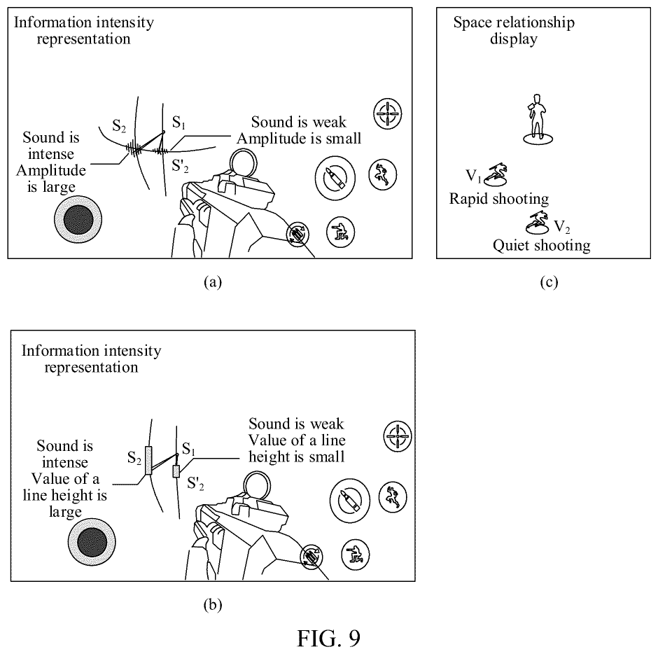

For example, it is assumed that the value of the acoustic wave amplitude parameter is M, the intensity of the target sound is N, and a relationship between M and N is that M=1.5N+3. To be specific, when the target sound is intense (with high intensity), acoustic wave amplitude is large, for example, a second marker S₂ shown in (a) in FIG. 9. On the contrary, when the target sound is weak (with low intensity), acoustic wave amplitude is small, for example, a second marker S′₂ shown in (a) in FIG. 9. From a space relationship display result shown in (c) in FIG. 9, intensity of a target sound V₁ is intense during rapid shooting; and intensity of a target sound V₂ is weak during quiet shooting.

For another example, it is assumed that the value M of the acoustic wave amplitude parameter is equal to 1 when the intensity N of the target sound is less than 20 db; the value M of the acoustic wave amplitude parameter is equal to 3 when the intensity N of the target sound is greater than or equal to 20 db and is less than 70 db; and the value M of the acoustic wave amplitude parameter is equal to 5 when the intensity N of the target sound is greater than or equal to 100 db. In other words, the value of the acoustic wave amplitude parameter is positively correlated with the interval boundary value of the intensity interval of the intensity of the target sound.

In another example, it is assumed that the intensity of the target sound is distinguished by using the acoustic wave amplitude parameter. In this case, the value of the acoustic wave amplitude parameter is negatively correlated with the intensity of the target sound, or the value of the acoustic wave amplitude parameter is negatively correlated with the interval boundary value of the intensity interval of the intensity of the target sound.

For example, it is assumed that the value of the acoustic wave amplitude parameter is M, the intensity of the target sound is N, a relationship between M and N is that M=P−N, and P is a constant. To be specific, when the target sound is intense, the value of the acoustic wave amplitude parameter is small; and when the target sound is weak, the value of the acoustic wave amplitude parameter is large.

For another example, it is assumed that the value M of the acoustic wave amplitude parameter is equal to 5 when the intensity N of the target sound is less than 20 db; the value M of the acoustic wave amplitude parameter is equal to 3 when the intensity N of the target sound is greater than or equal to 20 db and is less than 70 db; and the value M of the acoustic wave amplitude parameter is equal to 1 when the intensity N of the target sound is greater than or equal to 100 db. In other words, the value of the acoustic wave amplitude parameter is negatively correlated with the interval boundary value of the intensity interval of the intensity of the target sound.

### Embodiment 4

It is assumed that the intensity of the target sound is distinguished by using the line height parameter. In this case, the value of the line height parameter is positively correlated with the intensity of the target sound, or the value of the line height parameter is positively correlated with an interval boundary value of an intensity interval of the intensity of the target sound.

For example, it is assumed that the value of the line height parameter is T, the intensity of the target sound is N, and a relationship between T and N is that T=2N. To be specific, when the target sound is intense (with high intensity), the value of the line height parameter is large, for example, a second marker S₂ shown in (b) in FIG. 9. On the contrary, when the target sound is weak (with low intensity), the value of the line height parameter is small, for example, a second marker S′₂ shown in (b) in FIG. 9.

For another example, it is assumed that the value T of the line height parameter is equal to 1 when the intensity N of the target sound is less than 20 db; the value T of the line height parameter is equal to 2 when the intensity N of the target sound is greater than or equal to 20 db and is less than 70 db; and the value T of the line height parameter is equal to 3 when the intensity N of the target sound is greater than or equal to 100 db. In other words, the value of the line height parameter is positively correlated with the interval boundary value of the intensity interval of the intensity of the target sound.

In another example, it is assumed that the intensity of the target sound is distinguished by using the line height parameter. In this case, the value of the line height parameter is negatively correlated with the intensity of the target sound, or the value of the line height parameter is negatively correlated with the interval boundary value of the intensity interval of the intensity of the target sound.

For example, it is assumed that the value of the line height parameter is T, the intensity of the target sound is N, a relationship between T and N is that T=P−N, and P is a constant. To be specific, when the target sound is intense, the value of the line height parameter is small; and when the target sound is weak, the value of the line height parameter is large.

For another example, it is assumed that the value T of the line height parameter is equal to 3 when the intensity N of the target sound is less than 20 db; the value T of the line height parameter is equal to 2 when the intensity N of the target sound is greater than or equal to 20 db and is less than 70 db; and the value T of the line height parameter is equal to 1 when the intensity N of the target sound is greater than or equal to 100 db. In other words, the value of the line height parameter is negatively correlated with the interval boundary value of the intensity interval of the intensity of the target sound.

Apparently, the first display parameter and the second display parameter may also be combined, to display the second marker according to both the first display parameter and the second display parameter other than according to the first display parameter or according to the second display parameter. In other words, the second marker S₂ may be displayed according to both the distance between the target sound and the first virtual character and the intensity of the target sound.

Based on analyses of the foregoing embodiments, it may be learned that, the second marker may be displayed on the surface of the three-dimensional virtual sphere according to parameters such as the distance between the first space location and the second space location and/or the intensity of the target sound, so that the player can quickly and accurately determine the orientation information of the target sound with the help of a display pattern of the second marker, and determining efficiency and clarity of the orientation prompt information are improved.

In addition, in this embodiment of this disclosure, the foregoing method for displaying orientation prompt information further includes at least one of the following manners.

(1) As shown in FIG. 11, in a case that orientation prompt information of a third space location of the second virtual character is displayed in a first interface of the target gaming application in which the first virtual character is located, prompt information that orientation information of the second virtual character has been displayed is displayed in a second interface of the target gaming application in which the second virtual character is located.

(2) As shown in (a) in FIG. 3, it is assumed that a second target sound is generated in a case that a first target sound is generated at the second space location and a virtual attack performed by a third virtual character at a fourth space location hits the first virtual character. In this case, an orientation marker of the second space location and a type of the first target sound, and/or an orientation marker of the fourth space location of the third virtual character and a type of the second target sound are displayed on the three-dimensional virtual sphere.

The type of the first target sound and the type of the second target sound include, but are not limited to, aggressiveness, non-aggressiveness, and the like, and the fourth space location includes, but is not limited to, a location other than the first space location and the second space location.

(3) As shown in (a) in FIG. 3, it is assumed that in a case that the first target sound is generated at the second space location and the orientation marker of the second space location is displayed on the three-dimensional virtual sphere within preset duration, if a virtual character generating the first target sound moves from the second space location within a field of view of the first virtual character to another space location out of the field of view of the first virtual character, display of the orientation marker of the second space location is canceled. The virtual character generating the first target sound is a player virtual character or a non-player virtual character.

Through the foregoing manners, different display forms of the orientation prompt information may be set according to needs, which satisfies a personalized requirement of a user, improves flexibility of displaying the orientation prompt information, and increases fun of a game.

Apparently, the foregoing embodiments 1 to 4 mainly describe specific implementations for displaying the second marker when the first orientation prompt information is displayed by using the first marker, the second marker, and the first connecting line between the first marker and the second marker. In addition, the first orientation prompt information of the target sound may also be displayed according to the following manner. The manner includes:
displaying, in a case that the surface of the three-dimensional virtual sphere is divided into grids and the second marker corresponds to a target grid on the surface of the three-dimensional virtual sphere, the first marker and the first connecting line in the target gaming application, and displaying the target grid marked in a target color; or
displaying, in a case that the surface of the three-dimensional virtual sphere is divided into grids and the second marker corresponds to a target grid on the surface of the three-dimensional virtual sphere, the first marker and the first connecting line in the target gaming application, and displaying a grid in a partial area on the surface of the three-dimensional virtual sphere, where the grid in the partial area includes the target grid marked in a target color and a group of grids; and the group of grids are not marked in a color, or the group of grids are marked in a color different from the target color.

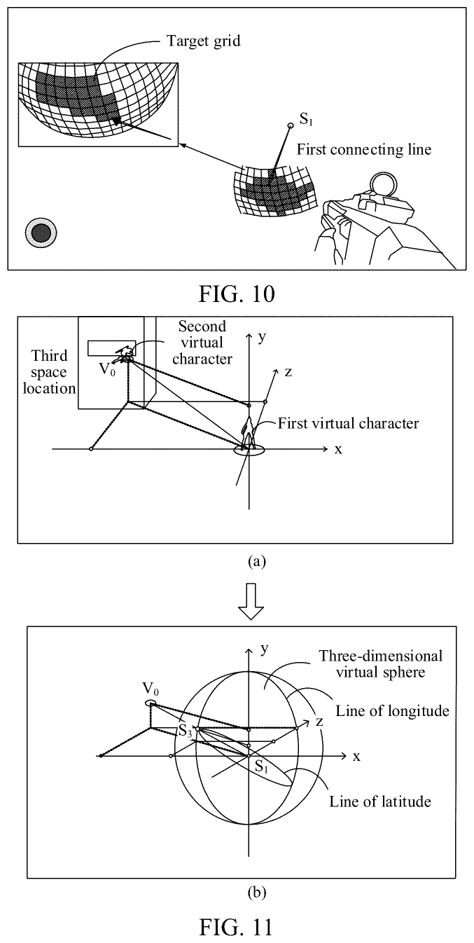

As shown in FIG. 10, it is assumed that the surface of the three-dimensional virtual sphere is divided into the grids, and the center S₁ of the three-dimensional virtual sphere indicates the first space location of the first virtual character. When the target sound is generated at the second space location, the target sound is mapped to the target grid on the surface of the three-dimensional virtual sphere, and the target grid is marked in the target color, for example, red. In this case, first orientation prompt information of the target sound is displayed by using the target grid marked in red and a group of grids around the target grid (i.e., neighboring grids), the first marker (the center of the sphere) S₁, and the first connecting line. The group of grids around the target grid have a same function as the lines of latitude and longitude of the three-dimensional virtual sphere described in the foregoing embodiments, and are mainly configured to assist in determining the orientation information of the target sound.

Because the target sound is propagated in a form of an acoustic wave generally, to more vividly display a visual expression of the sound, in an actual game scene, the target grid generally includes a plurality of grids. A center of a graph formed by the plurality of grids may be understood as the second marker S₂ indicating the target sound, and the first connecting line is a connecting line between S₁ and S₂.

The target grid shown in FIG. 10 is merely an example and is not limited. For example, a quantity of target grids may be 1 or any other quantity of 2 or more.

In addition, in a case that the target grid is marked in the target color, to distinguish the group of grids around the target grid from the target grid, the group of grids may be uncolored, or the group of grids may be marked in a color different from the target color. For example, the target grid is marked in red, and the group of grids are marked in blue.

In conclusion, the group of grids around the target grid are mainly configured to assist in determining the orientation information of the target sound. In this case, in some application scenarios, only the target grid marked in the target color may also be displayed, without displaying the group of grids around the target grid.

Through the foregoing manner, by displaying the target grid marked in the target color on the surface of the three-dimensional virtual sphere, or displaying the target grid marked in the target color and the group of grids around the target grid, a visual effect of the orientation prompt information of the target sound or being-attacked information is improved, thereby helping the player quickly determine an orientation of the target sound.

As described in the foregoing embodiments, the target sound may be, but is not limited to, a sound emitted by each scene element in a current game scene, such as a roar emitted by a virtual animal, or a gunshot emitted when a virtual character other than the first virtual character shoots. In this case, when the target sound is the being-attacked information of the first virtual character, the foregoing method further includes:
displaying second orientation prompt information of a second virtual character in the target gaming application in a case that a virtual attack performed by the second virtual character hits the first virtual character, where the second orientation prompt information includes the first marker, a third marker, and a second connecting line between the first marker and the third marker, the third marker is located on the surface of the three-dimensional virtual sphere, the third marker indicates a projection of a third space location at which the second virtual character is located on the three-dimensional virtual sphere, and the second connecting line indicates an orientation of the third space location of the second virtual character relative to the first space location.

As shown in (a) in FIG. 11, it is assumed that when the second virtual character performs a virtual attack task, the first virtual character is hit. In this case, the foregoing method for displaying orientation prompt information is used, to map the space location of the second virtual character to a third marker S₃ on the surface of the three-dimensional virtual sphere shown in (b) in FIG. 11, and map the third space location of the first virtual character to the center S₁ of the three-dimensional virtual sphere. In this case, the second orientation prompt information of the second virtual character is displayed by using the first marker, the third marker, and the second connecting line between the first marker and the third marker.

In a general case, the second orientation prompt information of the second virtual character needs to be displayed in the game interface only in a case that the second virtual character hits the first virtual character. However, in a case that the second virtual character performs the virtual attack but the first virtual character is not hit, there is no need to prompt the first virtual character with the orientation information of the being-attacked information (a shooting sound, or a shooting location of the second virtual character).

In an example, the displaying second orientation prompt information of a second virtual character in the target gaming application includes:
displaying the first marker, the third marker, the second connecting line, and lines of latitude and longitude of the third marker on the three-dimensional virtual sphere in the target gaming application, where the second orientation prompt information further includes the lines of latitude and longitude of the third marker on the three-dimensional virtual sphere.

Refer to descriptions in the foregoing embodiments, the lines of latitude and longitude are lines for determining a location and a direction on the three-dimensional virtual sphere. A line of longitude indicates a north-south direction, and a line of latitude indicates an east-west direction. In a three-dimensional virtual sphere shown in (b) in FIG. 11, a first relative location relationship between the third marker S₃ and the first marker S₁ on the xz-plane may be displayed by using a line of latitude for assistance, and a second relative location relationship between the third marker S₃ and the first marker S₁ in the y-axis direction may be displayed by using a line of longitude for assistance. In combination with the first relative location relationship and the second relative location relationship, it may be quickly determined that the target sound is behind and at the right of the first virtual character.

The second orientation prompt information of the second virtual character shown in FIG. 11 is merely an example and is not limited. For example, in an actual application scenario, a plurality of, such as two, three, or another quantity of, pieces of orientation prompt information may also be simultaneously displayed on the three-dimensional virtual sphere.

By using the lines of latitude and longitude on the three-dimensional virtual sphere, the player is assisted in determining orientation information of the third space location of the second virtual character, and a technical effect of improving determining efficiency and improving accuracy of a determining result is achieved.

In an example, the orientation prompt information of the target sound may also be displayed in the following manner other than a manner of displaying in a form of the three-dimensional virtual sphere. Specifically, the manner includes:
displaying third orientation prompt information on a thumbnail map in the target gaming application in a case that the target sound is generated at the second space location, where the thumbnail map is configured for displaying planar map information of a three-dimensional game scene in which the first virtual character is located and that is mapped to a target plane, the first space location is on the target plane, the third orientation prompt information includes an orientation of a planar projection location relative to the first space location on the target plane, and a target direction marker, the planar projection location is a projection location of the second space location on the target plane, and the target direction marker is configured for indicating that the second space location is above or below the target plane.

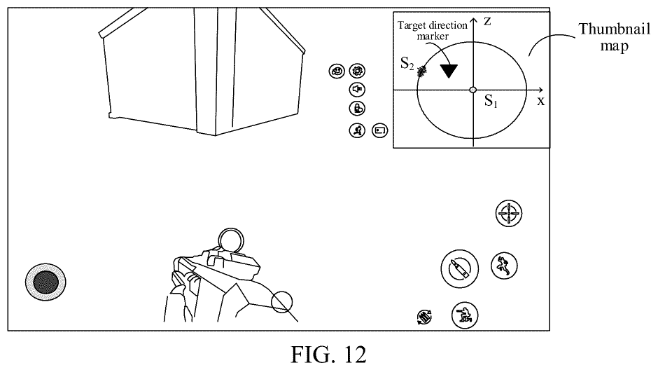

As shown in FIG. 12, on the thumbnail map, the first marker S₁ of the first space location of the first virtual character is displayed, and the second space location of the target sound is displayed in an annular area around the first marker S₁. In other words, projection locations of the first space location and the second space location on an xz-plane are displayed on the thumbnail map, and then that the second space location is above or below the xz-plane is indicated with the help of the target direction marker.

For example, by using the first marker S₁ and the second marker S₂ shown in FIG. 12, only a relative location relationship between the first space location and the second space location on the xz-plane can be displayed, but three-dimensional orientation information on a y axis cannot be accurately distinguished. However, with the help of a triangle icon, that the second space location is above or below the xz-plane may be accurately distinguished. For example, when an angle of the triangle icon faces downward, it indicates that the second space location is below the xz-plane; and on the contrary, when an angle of the triangle icon faces upward, it indicates that the second space location is above the xz-plane.

By adding the target direction marker on the thumbnail map, not only the orientation information that is of the second space location and the first space location and is displayed on the xz-plane can be displayed, but also the three-dimensional orientation information on the y axis can be well distinguished, which may help the player determine an orientation of the target sound, and increase diversity of display forms of the orientation prompt information.

The method for displaying the orientation prompt information is described in the foregoing embodiments mainly from a product side. How to display the first orientation prompt information of the target sound in the target gaming application is described in detail below from a perspective of a background technology.

Specifically, it includes: obtaining the first space location of the first virtual character and the second space location at which the target sound is generated;
mapping, according to a same mapping relationship in a case that a distance between the first space location and the second space location is less than or equal to a preset distance threshold, the first space location to the center of the three-dimensional virtual sphere, displaying the first marker on the center of the three-dimensional virtual sphere, and mapping the second space location to a target mapping location in a three-dimensional space of the three-dimensional virtual sphere; and
determining a location at which a target connecting line intersects with the surface of the three-dimensional virtual sphere, displaying the second marker at an intersection location, and displaying the first connecting line, where the target connecting line is a connecting line passing through the center of the three-dimensional virtual sphere and the target mapping location.

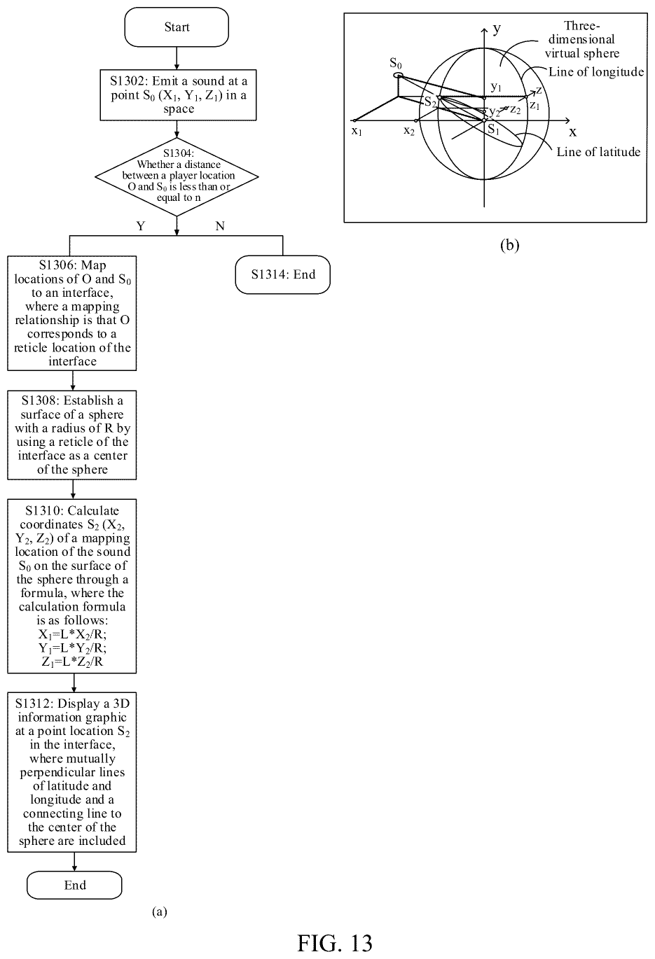

As shown in (a) in FIG. 13, an implementation operation of displaying the first orientation prompt information of the target sound in the target gaming application includes the following operations.

S1302: Obtain location information (X₁, Y₁, Z₁) of a second space location S₀ when the target sound is emitted at the second space location S₀ in a game scene.

For example, it is assumed that the first virtual character is located at the first space location shown in (a) in FIG. 3, and the target sound is at a second space location V₀ (space locations of S₀ and V₀ are the same) shown in (a) in FIG. 3.

S1304: Determine whether the distance between the first space location of the player and the second space location is less than or equal to the preset distance threshold.

In the game scene, according to a game rule, generally only a target sound within a preset range from the player is prompted. For example, only a target sound or being-attacked information within 100 meters from the player is prompted.

S1306: Map, in a case that the distance is less than or equal to the preset distance threshold, the first space location of the player is mapped to a screen reticle location, for example, S₁ shown in (b) in FIG. 13.

For the displayed game picture of the first virtual character in the target gaming application, a perspective with the first virtual character as a center is selected, and the first space location of the first virtual character is mapped to a center of the three-dimensional virtual sphere shown in (b) in FIG. 13.

S1308: Establish a surface of a sphere with a radius of R by using a reticle of an interface as a center of the sphere.

In this embodiment of this disclosure, a value of R is not limited.

S1310: Map, by using a same mapping relationship as the first space location, the second space location of the target sound to the target mapping location in the three-dimensional space of the three-dimensional virtual sphere.

For example, the second space location of the target sound is mapped to S₂ shown in (b) in FIG. 13. The following relationship exists between coordinates (X₂, Y₂, Z₂) of S₂ and coordinates (X₁, Y₁, Z₁) of S₁.

$${X}_{1} = L * {X}_{2} / R ;$$

$${Y}_{1} = L * {Y}_{2} / R ; and$$

$${Z}_{1} = L * {Z}_{2} / R .$$

L indicates a length from S₁ to S₀. R indicates a length from S₁ to S₂. In other words, R is a radius of the three-dimensional virtual sphere.

Because the value of R is different, it means that the target mapping location S₂ to which the second space location of the target sound is mapped and that is in the three-dimensional space of the three-dimensional virtual sphere is also different. The target mapping location S₂ may be on the surface of the three-dimensional virtual sphere, or may be inside the three-dimensional virtual sphere.

When the target mapping location S₂ is on the surface of the three-dimensional virtual sphere, a connecting line between S₁ and S₂ is directly determined as the first connecting line. When the target mapping location S₂ is inside the three-dimensional virtual sphere, a connecting line between S₁ and S₂ is extended until there is an intersection point with the surface of the three-dimensional virtual sphere. The intersection point and the connecting line between S₁ and S₂ are determined as the first connecting line.

Apparently, in this embodiment of this disclosure, according to the same mapping relationship, the first space location of the first virtual character and the second space location of the target sound are respectively mapped to the center of the three-dimensional virtual sphere and the target mapping location in the three-dimensional space of the three-dimensional virtual sphere.

S1312: Display a 3D information graphic at the point S₂ in the interface, where mutually perpendicular lines of latitude and longitude and a connecting line to the center of the sphere are included.

For a specific expression form of the information graphic, refer to the acoustic wave shape shown by the point S₂ in FIG. 6 and FIG. 7, a line shape pattern shown in (b) in FIG. 9, or the like. By using a target connecting line between S₁ and S₂, and an information pattern of the point S₂, the first orientation prompt information of the target sound is displayed in the target gaming application.

Through the foregoing embodiment provided in this disclosure, by using the same mapping relationship, the first space location and the second space location are respectively mapped to two mapping locations in the three-dimensional space of the three-dimensional virtual sphere in the interface, and then the orientation prompt information of the target sound is displayed by using the two mapping locations and a connecting line between the two mapping locations, so that the orientation prompt information of the target sound is more accurate, the technical problem of low accuracy appearing during displaying of the orientation prompt information is avoided, and a technical effect of improving accuracy of displaying the orientation prompt information is achieved.

For case of description, the foregoing method embodiments are described as a series of action combinations. However, this disclosure is not limited to the described order of the actions because some operations may be performed in another order or performed at the same time according to this disclosure. In addition, the embodiments described in this specification are all exemplary embodiments, and the involved actions and modules are not necessarily required to this disclosure.

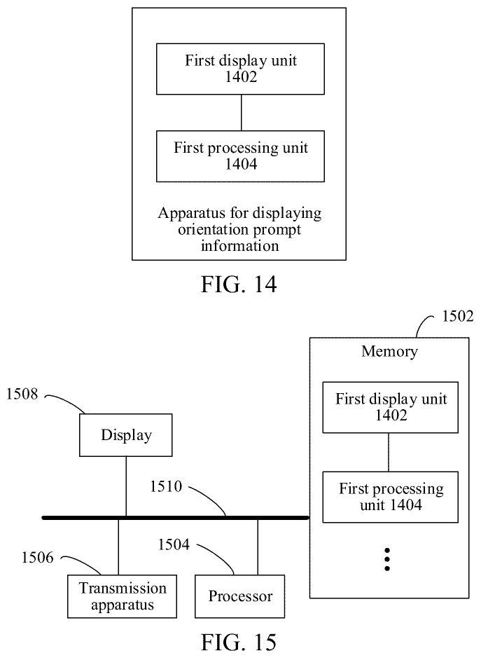

According to another aspect of the embodiments of this disclosure, an apparatus for displaying orientation prompt information as shown in FIG. 14 is provided. The apparatus includes:
a first display unit 1402, configured to display a game picture of a first virtual character in a target gaming application; and
a first processing unit 1404, configured to display first orientation prompt information of a target sound in the target gaming application in a case that the target sound is generated at a second space location, the first orientation prompt information including a first marker, a second marker, and a first connecting line between the first marker and the second marker, the first marker being located at a center of a three-dimensional virtual sphere, the first marker indicating a first space location of the first virtual character, the second marker being located on a surface of the three-dimensional virtual sphere, the second marker indicating a projection of a second space location of the target sound on the three-dimensional virtual sphere, and the first connecting line indicating an orientation of the second space location relative to the first space location.

In some embodiments, the foregoing first processing unit 1404 includes:
a first display module, configured to display the first marker, the second marker, the first connecting line, and lines of latitude and longitude of the second marker on the three-dimensional virtual sphere in the target gaming application, where the first orientation prompt information further includes the lines of latitude and longitude of the second marker on the three-dimensional virtual sphere.

In some embodiments, the foregoing first processing unit 1404 includes:
a second display module, configured to display the first marker and the first connecting line in the target gaming application, and display the second marker according to a first display parameter, where a value of the first display parameter corresponds to a target distance, and the target distance is a distance between the second space location and the first space location.

In some embodiments, the foregoing second display module includes:
a first processing submodule, configured to display the second marker according to a transparency parameter in a case that the first display parameter is the transparency parameter, where a value of the transparency parameter indicates transparency of the second marker when the second marker is displayed; or
display the second marker according to a color parameter in a case that the first display parameter is the color parameter, where a value of the color parameter indicates a color of the second marker when the second marker is displayed.

In some embodiments, the foregoing first processing unit 1404 includes:
a third display module, configured to display the first marker and the first connecting line in the target gaming application, and display the second marker according to a second display parameter, where a value of the second display parameter corresponds to intensity of the target sound.

In some embodiments, the foregoing third display module includes:
a second processing submodule, configured to display a marker of an acoustic wave shape according to an acoustic wave amplitude parameter in a case that the second marker is the marker of the acoustic wave shape and the second display parameter is the acoustic wave amplitude parameter, where a value of the acoustic wave amplitude parameter indicates amplitude of the marker of the acoustic wave shape when the marker of the acoustic wave shape is displayed, and the value of the acoustic wave amplitude parameter is positively correlated with the intensity of the target sound; or
display a marker of a line shape according to a line height parameter in a case that the second marker is the marker of the line shape and the second display parameter is the line height parameter, where a value of the line height parameter indicates a line height of the marker of the line shape when the marker of the line shape is displayed, and the value of the line height parameter is positively correlated with the intensity of the target sound.

In some embodiments, the foregoing apparatus further includes:
a second processing unit, configured to display second orientation prompt information of a second virtual character in the target gaming application in a case that a virtual attack performed by the second virtual character hits the first virtual character, where the second orientation prompt information includes the first marker, a third marker, and a second connecting line between the first marker and the third marker, the third marker is located on the surface of the three-dimensional virtual sphere, the third marker indicates a projection of a third space location of the second virtual character on the three-dimensional virtual sphere, and the second connecting line indicates an orientation of the third space location of the second virtual character relative to the first space location.

In some embodiments, the foregoing second processing unit includes:
a fourth display module, configured to display the first marker, the third marker, the second connecting line, and lines of latitude and longitude of the third marker on the three-dimensional virtual sphere in the target gaming application, where the second orientation prompt information further includes the lines of latitude and longitude of the third marker on the three-dimensional virtual sphere.

In some embodiments, the foregoing first processing unit 1404 further includes:
a first processing module, configured to display, in a case that the surface of the three-dimensional virtual sphere is divided into grids and the second marker corresponds to a target grid on the surface of the three-dimensional virtual sphere, the first marker and the first connecting line in the target gaming application, and display the target grid marked in a target color; or
display, in a case that the surface of the three-dimensional virtual sphere is divided into grids and the second marker corresponds to a target grid on the surface of the three-dimensional virtual sphere, the first marker and the first connecting line in the target gaming application, and display a grid in a partial area on the surface of the three-dimensional virtual sphere, where the grid in the partial area includes the target grid marked in a target color and a group of grids; and the group of grids are not marked in a color, or the group of grids are marked in a color different from the target color.

In some embodiments, the foregoing apparatus further includes:
a third processing unit, configured to display third orientation prompt information on a thumbnail map in the target gaming application in a case that the target sound is generated at the second space location, where the thumbnail map is configured for displaying planar map information of a three-dimensional game scene in which the first virtual character is located and that is mapped to a target plane, the first space location is on the target plane, the third orientation prompt information includes an orientation of a planar projection location relative to the first space location on the target plane, and a target direction marker, the planar projection location is a projection location of the second space location on the target plane, and the target direction marker is configured for indicating that the second space location is above or below the target plane.

In some embodiments, the foregoing first processing unit 1404 further includes:
an obtaining module, configured to obtain the first space location of the first virtual character and the second space location at which the target sound is generated;
a second processing module, configured to map, according to a same mapping relationship in a case that a distance between the first space location and the second space location is less than or equal to a preset distance threshold, the first space location to the center of the three-dimensional virtual sphere, display the first marker on the center of the three-dimensional virtual sphere, and map the second space location to a target mapping location in a three-dimensional space of the three-dimensional virtual sphere; and
a third processing module, configured to determine a location at which a target connecting line intersects with the surface of the three-dimensional virtual sphere, display the second marker at an intersection location, and display the first connecting line, where the target connecting line is a connecting line passing through the center of the three-dimensional virtual sphere and the target mapping location.

By using the foregoing apparatus in the displayed game picture of the first virtual character, the second space location of the target sound and the first space location of the first virtual character are respectively mapped to the center (the first marker) of the three-dimensional virtual sphere and the second marker on the surface, and the orientation of the second space location relative to the first space location is indicated by using the first connecting line between the first marker and the second marker. In other words, display information in a y-axis direction is added in the three-dimensional virtual sphere, so that the orientation prompt information of the target sound is more accurate, the technical problem of low accuracy appearing during displaying of the orientation prompt information is avoided, and a technical effect of improving accuracy of displaying the orientation prompt information is achieved.

For the embodiment of the apparatus for displaying the orientation prompt information herein, refer to the foregoing embodiment of the method for displaying the orientation prompt information. Details are not described herein again.

According to another aspect of the embodiments of this disclosure, an electronic device for implementing the foregoing method for displaying the orientation prompt information is further provided. The electronic device may be a terminal device shown in FIG. 15. In this embodiment, description is made by using an example in which the electronic device is a background device. As shown in FIG. 15, the electronic device includes a memory 1502 and a processor 1504. The memory 1502 has a computer program stored therein. The processor 1504 is configured to perform the operations in any one of the foregoing method embodiments through the computer program.

In some embodiments, in this embodiment, the foregoing electronic device may be located in at least one of a plurality of network devices in a computer network.

In some embodiments, in this embodiment, the processor may be configured to perform the following operations by executing the computer program.

S₁: Display a game picture of a first virtual character in a target gaming application.

S₂: Display first orientation prompt information of a target sound in the target gaming application in a case that the target sound is generated at a second space location, the first orientation prompt information including a first marker, a second marker, and a first connecting line between the first marker and the second marker, the first marker being located at a center of a three-dimensional virtual sphere, the first marker indicating a first space location of the first virtual character, the second marker being located on a surface of the three-dimensional virtual sphere, the second marker indicating a projection of a second space location of the target sound on the three-dimensional virtual sphere, and the first connecting line indicating an orientation of the second space location relative to the first space location.

In some embodiments, the structure shown in FIG. 15 is only schematic. The electronic device may alternatively be a target terminal such as a smartphone (such as an Android mobile phone or an iOS mobile phone), a tablet computer, a palmtop computer, a mobile Internet device (MID), or a PAD. FIG. 15 does not limit the structure of the electronic device. For example, the electronic device may further include more or fewer components (such as a network interface) than those shown in FIG. 15, or have a configuration different from that shown in FIG. 15.

The memory 1502 may be configured to store a software program and module, for example, a program instruction/module corresponding to the method and the apparatus for displaying the orientation prompt information in the embodiments of this disclosure, and the processor 1504 runs the software program and module stored in the memory 1502, to perform various function applications and data processing, in other words, implement the foregoing method for displaying the orientation prompt information. The memory 1502 may include a high-speed random access memory, and may further include a non-volatile memory such as one or more magnetic storage apparatuses, a flash memory, or another non-volatile solid-state memory. In some embodiments, the memory 1502 may further include memories remotely disposed relative to the processor 1504, and these remote memories may be connected to the terminal through a network. The foregoing examples of the network include, but are not limited to, the Internet, an intranet, a local area network, a mobile communication network, and a combination thereof. The memory 1502 may specifically be configured to store the first space location of the first virtual character, the second space location of the target sound, a mapping relationship between the first space location and the second space location, and the like, but is not limited thereto. In an example, as shown in FIG. 15, the memory 1502 may include, but is not limited to, the first display unit 1402 and the first processing unit 1404 in the foregoing apparatus for displaying the orientation prompt information. In addition, the memory may further include, but is not limited to, other modules and units in the foregoing apparatus for displaying the orientation prompt information. Details are not described in this example again.

In some embodiments, the transmission apparatus 1506 is configured to receive or transmit data through a network. Specific examples of the network include a wired network and a wireless network. In an example, the transmission apparatus 1506 includes a network interface controller (NIC). The NIC may be connected to another network device and a router by using a network cable to communicate with the Internet or a local area network. In an example, the transmission apparatus 1506 is a radio frequency (RF) module, and is configured to communicate with the Internet in a wireless manner.

In addition, the electronic device further includes: a display 1508, configured to display the foregoing target sound and the orientation prompt information; and a connection bus 1510, configured to connect various module components in the electronic device.

In other embodiments, the target terminal or the server may be a node in a distributed system, where the distributed system may be a blockchain system, and the blockchain system may be a distributed system formed by connecting a plurality of nodes in through network communication. A peer to peer (P2P) network may be formed between the nodes. A computing device in any form, for example, an electronic device such as a server or a terminal, may become a node in the blockchain system by joining the P2P network.

According to an aspect of this disclosure, a computer program product or a computer program is provided, the computer program product or the computer program including computer instructions, the computer instructions being stored in a computer-readable storage medium. A processor of a computer device reads the computer instructions from the computer-readable storage medium, and executes the computer instructions, so that the computer device performs the method for displaying the orientation prompt information provided in the exemplary implementations in the foregoing aspects such as server verification processing, where the computer program, when run, is configured for performing the operations in any foregoing method embodiments.

In some embodiments, in this embodiment, the computer-readable storage medium may be configured to store a computer program configured to perform the following operations.

S₁: Display a game picture of a first virtual character in a target gaming application.

S₂: Display first orientation prompt information of a target sound in the target gaming application in a case that the target sound is generated at a second space location, the first orientation prompt information including a first marker, a second marker, and a first connecting line between the first marker and the second marker, the first marker being located at a center of a three-dimensional virtual sphere, the first marker indicating a first space location of the first virtual character, the second marker being located on a surface of the three-dimensional virtual sphere, the second marker indicating a projection of a second space location of the target sound on the three-dimensional virtual sphere, and the first connecting line indicating an orientation of the second space location relative to the first space location.

In some embodiments, all or some of the operations of the methods in the foregoing embodiments may be implemented by a program instructing relevant hardware of the target terminal. The program may be stored in a non-transitory computer-readable storage medium. The storage medium may comprise: a flash disk, a read-only memory (ROM), a random access memory (RAM), a magnetic disk, or an optical disc.

The sequence numbers of the foregoing embodiments of this disclosure are merely for description purpose, and do not indicate the preference among the embodiments.

When the integrated unit in the foregoing embodiments is implemented in the form of a software function unit and sold or used as an independent product, the integrated unit may be stored in the foregoing computer-readable storage medium. Based on such an understanding, the technical solutions of this disclosure essentially, or the part contributing to the related art, or all or some of the technical solutions may be expressed in a form of a software product. The computer software product is stored in a storage medium and includes several instructions for instructing one or more computer devices (which may be a personal computer, a server, or a network device) to perform all or some of the operations of the methods in the embodiments of this disclosure.

In the foregoing embodiments of this disclosure, the descriptions of the embodiments have respective focuses. For a part that is not described in detail in an embodiment, refer to related descriptions in other embodiments.

In the several embodiments provided in this disclosure, the disclosed client may be implemented in other manners. The described apparatus embodiments are merely exemplary. For example, the unit division is merely logical function division, and may use other division manners during actual implementation. For example, a plurality of units or components may be combined or integrated into another system, or some features may be omitted or not performed. In addition, the displayed or discussed mutual couplings or direct couplings or communication connections may be implemented through some interfaces. The indirect couplings or communication connections between the units or modules may be implemented in electronic or another form.

The units described as separate parts may or may not be physically separate, and components displayed as units may or may not be physical units, that is, may be located in one position, or may be distributed on a plurality of network units. Some or all of the units may be selected according to an actual requirement to achieve the objectives of the solutions in the embodiments.

In addition, functional units in the embodiments of this disclosure may be integrated into one processing unit, or each of the units may exist alone physically, or two or more units are integrated into one unit. The integrated unit may be implemented in the form of hardware, or may be implemented in the form of a software function unit.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are exemplary implementations of this disclosure. Some modifications can be made without departing from the principle of this disclosure.

What is claimed is:

1. A method for displaying orientation prompt information, comprising:
displaying a game image including a first virtual character at a first space location in a game scene of a target gaming application, a target sound associated with a second space location being generated in the game scene; and
displaying first orientation prompt information of the target sound according to a three-dimensional virtual sphere in the game image, the first orientation prompt information comprising a first marker, a second marker, and a first connecting line between the first marker and the second marker, the first marker being located at a first location of the three-dimensional virtual sphere, the first location being associated with the first space location of the first virtual character in the game scene, the second marker being located at a second location of the three-dimensional virtual sphere, the second location being associated with the second space location of the target sound in the game scene, and the first connecting line indicating a first orientation of the second space location relative to the first space location.

2. The method according to claim 1, wherein the first orientation prompt information further comprises lines of latitude and longitude of the second marker on the three-dimensional virtual sphere.

3. The method according to claim 1, wherein the first location is a center of the three-dimensional virtual sphere.

4. The method according to claim 3, wherein the second location is a surface location on a surface of the three-dimensional virtual sphere and corresponds to a projection of the second space location on the surface of the three-dimensional virtual sphere.

5. The method according to claim 1, wherein the displaying the first orientation prompt information comprises:
displaying the second marker according to a first display parameter with a first value that is determined according to a distance between the second space location and the first space location.

6. The method according to claim 5, wherein the displaying the second marker comprises:
displaying the second marker according to a transparency parameter with a transparency value determined according to the distance between the second space location and the first space location.

7. The method according to claim 5, wherein the displaying the second marker comprises:
displaying the second marker according to a color parameter with a color value determined according to the distance between the second space location and the first space location.

8. The method according to claim 1, wherein the displaying the first orientation prompt information comprises:
displaying the second marker according to a second display parameter with a second value that is determined according to an intensity of the target sound.

9. The method according to claim 8, wherein the displaying the second marker comprises:
displaying a marker of an acoustic wave shape according to an acoustic wave amplitude parameter with, a value of the acoustic wave amplitude parameter being positively correlated with the intensity of the target sound.

10. The method according to claim 8, wherein the displaying the second marker comprises:
displaying a marker of a line shape according to a line height parameter with a value of the line height parameter being positively correlated with the intensity of the target sound.

11. The method according to claim 1, further comprising:
displaying second orientation prompt information of a second virtual character in the game scene according to the three-dimensional virtual sphere in the game image when a virtual attack performed by the second virtual character at a third space location in the game scene hits the first virtual character, wherein the second orientation prompt information comprises the first marker, a third marker, and a second connecting line between the first marker and the third marker, the third marker is located at a third location of the three-dimensional virtual sphere that is associated with the third space location of the second virtual character in the game scene, and the second connecting line indicates a second orientation of the third space location relative to the first space location.

12. The method according to claim 11, wherein the third location is a surface location of the three-dimensional virtual sphere corresponding to a projection of the third space location on the three-dimensional virtual sphere.

13. The method according to claim 11, wherein the second orientation prompt information further comprises lines of latitude and longitude of the third marker on the three-dimensional virtual sphere.

14. The method according to claim 4, wherein the displaying the first orientation prompt information comprises:
displaying, when the surface of the three-dimensional virtual sphere is divided into grids and the second marker corresponds to a target grid on the surface of the three-dimensional virtual sphere, the target grid with a target color.

15. The method according to claim 14, wherein the displaying the first orientation prompt information comprises:
displaying a group of neighboring grids to the target grid with no color or a different color value from the target color.

16. The method according to claim 1, further comprising:
displaying third orientation prompt information on a thumbnail map, wherein the thumbnail map is configured to display planar map information of the game scene by a target plane including the first space location, the third orientation prompt information comprises an orientation of a planar projection location of the second space location on the target plane relative to the first space location on the target plane, and a target direction marker to indicate that the second space location is above or below the target plane.

17. The method according to claim 4, wherein the displaying the first orientation prompt information comprises:
obtaining the first space location of the first virtual character and the second space location of the target sound;
mapping, according to a same mapping relationship when a distance between the first space location and the second space location is less than or equal to a preset distance threshold, the first space location to the center of the three-dimensional virtual sphere, and the second space location to a target mapping location in a three-dimensional space of the three-dimensional virtual sphere;
determining an intersection location at which a target connecting line of the center of the three-dimensional virtual sphere and the target mapping location intersects with the surface of the three-dimensional virtual sphere; and
displaying the first marker at the center of the three-dimensional virtual sphere and the second marker at the intersection location.

18. An apparatus, comprising processing circuitry configured to:
display a game image including a first virtual character at a first space location in a game scene of a target gaming application, a target sound associated with a second space location being generated in the game scene; and
display first orientation prompt information of the target sound according to a three-dimensional virtual sphere in the game image, the first orientation prompt information comprising a first marker, a second marker, and a first connecting line between the first marker and the second marker, the first marker being located at a first location of the three-dimensional virtual sphere, the first location being associated with the first space location of the first virtual character in the game scene, the second marker being located at a second location of the three-dimensional virtual sphere, the second location being associated with the second space location of the target sound in the game scene, and the first connecting line indicating a first orientation of the second space location relative to the first space location.

19. The apparatus according to claim 18, wherein the first location is a center of the three-dimensional virtual sphere, the second location is a surface location on a surface of the three-dimensional virtual sphere and corresponds to a projection of the second space location on the surface of the three-dimensional virtual sphere.

20. A non-transitory computer-readable storage medium storing instructions which when executed by at least one processor cause the at least one processor to perform:
displaying a game image including a first virtual character at a first space location in a game scene of a target gaming application, a target sound associated with a second space location being generated in the game scene; and
displaying first orientation prompt information of the target sound according to a three-dimensional virtual sphere in the game image, the first orientation prompt information comprising a first marker, a second marker, and a first connecting line between the first marker and the second marker, the first marker being located at a first location of the three-dimensional virtual sphere, the first location being associated with the first space location of the first virtual character in the game scene, the second marker being located at a second location of the three-dimensional virtual sphere, the second location being associated with the second space location of the target sound in the game scene, and the first connecting line indicating a first orientation of the second space location relative to the first space location.
